(19) United States
(12) Patent Application Publication
(10) Pub. No.: US 2024/0033752 A1
(43) Pub. Date: Feb. 1, 2024

(54) Removal of Magnetite from Sample Mixtures

(71) Applicant: James Richmond, Redding, CA (US)

(72) Inventor: James Richmond, Redding, CA (US)

(21) Appl. No.: 17/874,068

(22) Filed: Jul. 26, 2022

(51) Int. Cl. B03C 1/03; C01G 49/08; B03C 1/034

(52) U.S. Cl. CPC B03C 1/03; C01G 49/08; B03C 1/034

(57) ABSTRACT

A separation apparatus having a first tube having an inside diameter and a height, a second tube having an outside diameter and substantially the height of the first tube, the second tube concentric with the first tube, the tubes having a common center-line, a spiral track implemented between the first tube and the second tube, the spiral track descending along the first and second tubes, and a plurality of magnet assemblies positioned on an outside wall of the first tube, providing magnetic fields through the outside wall of the first tube into regions where the spiral track meets the inside diameter of the first tube. A material mixture is introduced at an upper end of the apparatus, entrained in water down the spiral track, and some of the magnetic particles are separated from the material mixture and retained in the magnetic field of individual ones of the magnet assemblies.

### BACKGROUND OF THE INVENTION

### 1. Field of the Invention

The present invention is in the technical field of mining operations and pertains particularly to a step in a process of gold and heavy mineral recovery.

### 2. Description of Related Art

One well-known procedure of gold recovery is collecting and processing material from the bottom of streams and rivers, particularly streams and rivers in regions known to have produced gold in the past. In a simple operation a person may collect small amounts of river-bottom material and process the material by what is known as panning, wherein the material thought to contain gold is placed in a wide, curved medium-sized pan along with water. The miner moves the pan in a series of motions designed to eject lighter sediments leaving the much heavier gold particles and gold dust in the pan. In much more sophisticated operations large volumes of bottom sediment are dredged from the bottom of the stream or river and processed by various sorts of gravity recovery equipment, often called sluice boxes.

In both simple and more advanced mining operations a very common problem is accumulation of magnetite in the gravity recovery equipment. Gold deposits are often found integrated with magnetite, which is a mineral whose primary component is an iron oxide that contains equal amounts of iron(II) and iron(III). The empirical formula for magnetite is Fe₃O₄, and it is often expressed as iron(II, III) oxide. In the past, it has been called ferrous—ferric oxide and tri-iron tetraoxide. This material is magnetically permeable. The river bottom material that is collected and processed comes from gold deposits integrated with magnetite.

To simplify and reduce the costs of gold recovery what is clearly needed is apparatus and methods to separate magnetite from collected material, which is typically sand and gravel mixed with magnetite and traces of gold.

### BRIEF SUMMARY OF THE INVENTION

In an embodiment of the invention a separation apparatus is provided, comprising a vertically-oriented first tube having an inside diameter and a height, a second tube having an outside diameter substantially smaller than the inside diameter of the first tube and substantially the height of the first tube, the second tube concentric with the first tube, the tubes having a common center-line, a spiral track implemented between the inside diameter of the first tube and the outside diameter of the second tube, the spiral track descending along substantially the height of the first and second tubes, and a plurality of magnet assemblies, individual ones of the magnet assemblies positioned on an outside wall of the first tube, providing magnetic fields through the outside wall of the first tube into regions where the spiral track meets the inside diameter of the first tube. A material mixture comprising magnetic particles is introduced at an upper end of the apparatus, entrained in a flow of water down the spiral track, and some of the magnetic particles are separated from the material mixture and retained in the magnetic field of individual ones of the magnet assemblies.

In one embodiment the separation apparatus further comprises a container having an open top into which the apparatus empties such that processed material with magnetic particles removed is collected. Also, in one embodiment the magnetic particles constitute magnetite sand. In one embodiment water is fed to the second tube at a lowermost point, travels up the second tube, exits at a top of the second tube, flows onto the spiral track between the tubes, and material mixture is added to the water flow in the spiral track. And in one embodiment the magnet assemblies are positioned on the outside wall of the first tube in increments of 120 degrees following down the spiral track.

In one embodiment the magnet assemblies each comprise a permanent magnet. Also, in one embodiment the permanent magnets are Neodymium N52 magnets. Also, in one embodiment the magnet assemblies each comprise a permanent magnet joined to a magnetically permeable strip, the strip shaping the magnetic field. In one embodiment the first tube has a reducer fitting at a lower end of the first tube, further comprising a manually-adjustable flow controller coupled to the reducer fitting, enabling control of volume flow of entrained material and water down the spiral track. And in one embodiment the apparatus further comprises horizontally directed holes through a wall of the second tube at specific points along the spiral track and a cap with holes at the top of the second tube, such that water under pressure provided to the first tube at the lowermost end is directed outward over the spiral track at the specific points, and urges material to the outside of the spiral track.

In another aspect of the invention a method for separating magnetic particles from a material mixture is provided, comprising implementing a spiral track between first and a second concentric tubes, positioning magnet assemblies at specific points on the outside of the first tube along the spiral track, proving magnetic fields through the first tube, introducing a material mixture containing the magnetic particles onto the spiral track, flowing water onto the spiral track entraining the material mixture, and capturing magnetic particles in the magnetic fields.

In one embodiment the method further comprises collecting processed material mixture at the lower end of the spiral track in a container having an open top. In one embodiment the method comprises introducing a material mixture comprising magnetite sand. In one embodiment the method comprises feeding water to the second tube at a lowermost point, urging the water up the second tube, flowing the water out at the top of the second tube, flowing the water onto the spiral track between the tubes, and adding material mixture to the water flow in the spiral track. In one embodiment the method comprises positioning the magnet assemblies on the outside wall of the first tube in increments of 120 degrees following down the spiral track.

In one embodiment the method comprises providing a permanent magnet with each magnet assembly. In one embodiment the method comprises joining a permanent magnet to a magnetically permeable strip for each magnet assembly. In one embodiment the method comprises adjusting a manually-adjustable flow controller coupled to the reducer fitting, controlling volume flow of entrained material and water down the spiral track. And in one embodiment the method further comprises placing horizontally directed holes through a wall of the second tube at specific points along the spiral track and closing the top of the second tube with a cap having holes, such that water under pressure provided to the first tube at the lowermost end is directed outward over the spiral track at the specific points and urges material to the outside of the spiral track.

### BRIEF DESCRIPTION OF THE SEVERAL VIEWS OF THE DRAWINGS

FIG. 1 is a perspective vertical elevation view of an apparatus for separating magnetite sand from material mixtures.

FIG. 2A is a cross section of the apparatus of FIG. 1, taken along a vertical centerline of the apparatus.

FIG. 2B is an enlarged view of the upper end of tube 106 and cap 108 in cross section.

FIG. 2C is an enlarged portion of the cross section of FIG. 2A showing a certain height of the apparatus in section.

FIG. 2D is a further enlarged portion of the section of FIG. 2C showing magnet placement.

FIG. 2E is a view of the section of FIG. 2D with magnetite sand collected.

FIG. 3 illustrates an apparatus of the invention in use with other elements.

FIG. 4 is a perspective view of a magnetic plate and electromagnet assembly.

### DETAILED DESCRIPTION OF THE INVENTION

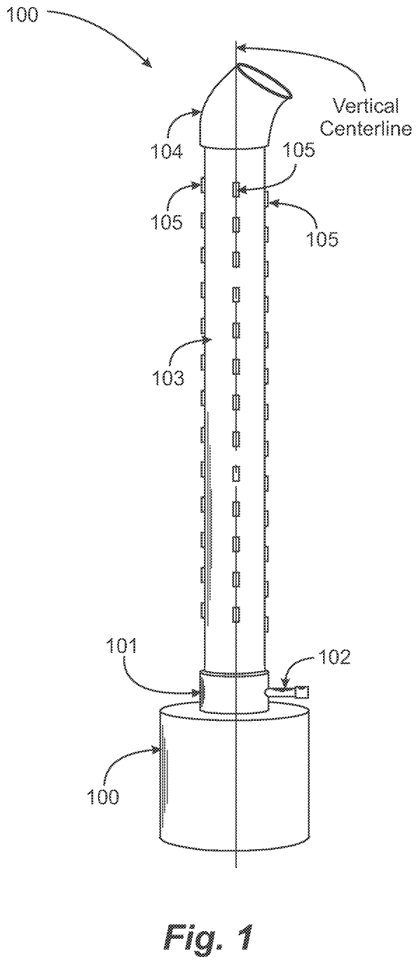

FIG. 1 is a perspective vertical elevation view of an apparatus 100 for separating magnetite from material mixtures. Apparatus 100 comprises in this example a 4 inch outside diameter vertical tube 103 joined to a lower plastic pipe element 101, in turn joined to an inverted plastic bucket 119, open at the bottom end. Vertical tube 103 in most embodiments is transparent plastic, so a user may witness action inside the apparatus, but inner elements are not shown in FIG. 1. Also, the outside diameter of tube 103 may be different in different embodiments. An entry chute 104 is established at an upper end for guiding loading of material mixtures into the apparatus for processing. Apparatus 100 except for chute 104 is symmetrical about a vertical centerline labeled in FIG. 1. A water inlet tube assembly 102 passes horizontally through an outside wall of pipe element 101 at a lower position near the bottom of tube 103.

A plurality of magnet assemblies 105 are positioned on an outside wall of tube 103. In this implementation magnet assemblies 105 are provided along a spiral path with individual ones of the magnet assemblies at a spacing of 90 degrees around tube 103 and at a spacing of 0.625 inches along the height of tube 103. This placement corresponds to a spiral path around tube 103 with a spiral period of 2.5 inches. The spacing is described in further detail below. In one embodiment magnet assemblies are not provided for the first two or three turns of the spiral track from the top, to allow a flow and some separation to take place before entrained material encounters a magnetic field.

As described above the diameter of tube 103 may be different in different embodiments. Also, the positioning and spacing of the magnet assemblies may be different in different embodiments as may be the overall height of apparatus 100. There are numerous internal elements that are not seen in FIG. 1 but illustrated in detail below with reference to other figures.

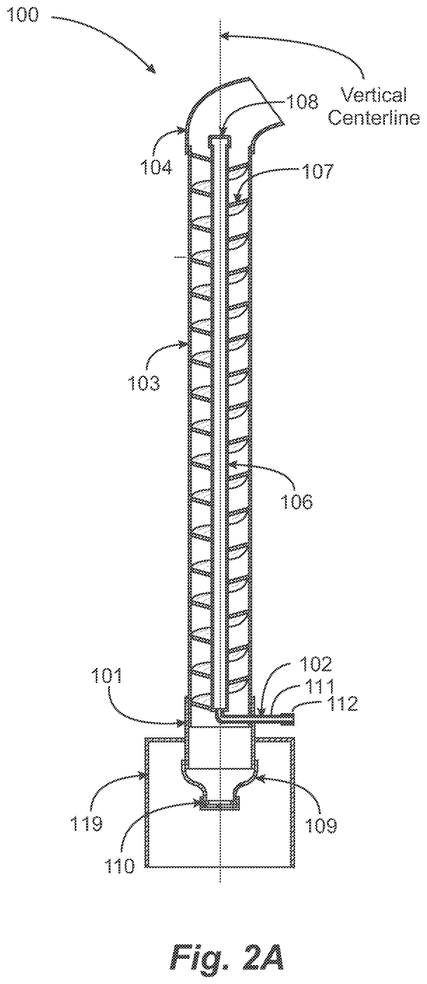

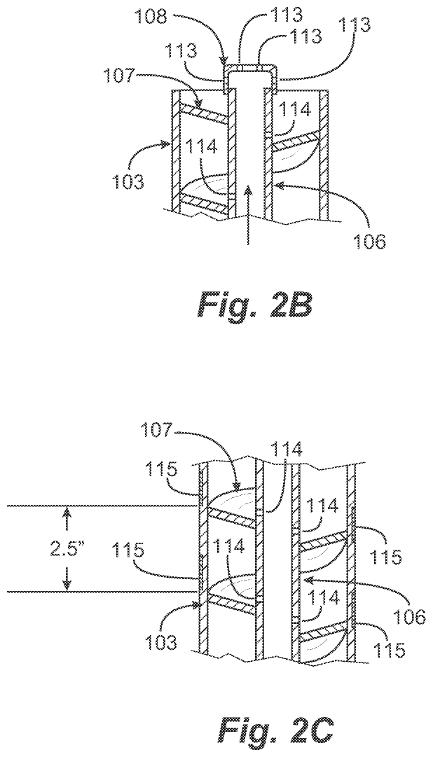

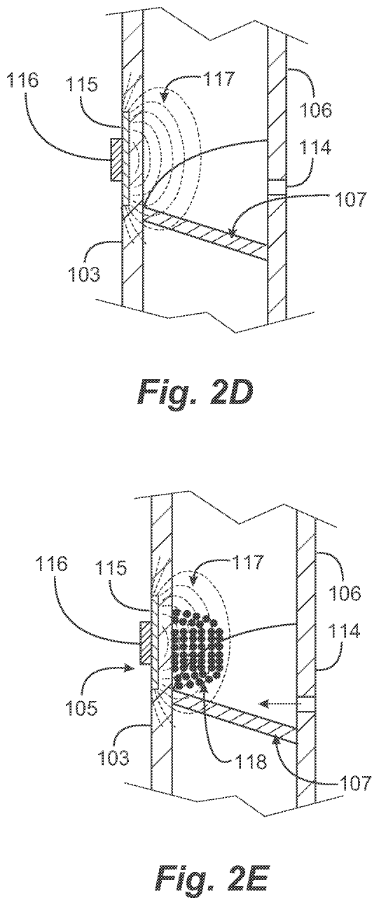

FIG. 2A is a cross section of apparatus 100 of FIG. 1, taken along a vertical centerline of the apparatus. An important element not seen in FIG. 1 is a central pipe 106 with a closed lower end and a water supply assembly 102 comprising a tube 111 and a quick-connect fitting 112 adapted to supply water into the lower end of central pipe 106. With assembly 102 connected to a water supply under pressure water courses into central pipe 106 and flows upward to cap 108, which has a series of holes around an outside rim and through a top wall. Water passes through these holes in cap 108 and flows downward along a spiral track 107 that connects between the outside of central pipe 106 and the inner wall of tube 103. This spiral track in this particular example has a period of 2.5 inches and the track is angled toward the central pipe from the outer tube by about fifteen degrees in this example. That inclination may be different in different embodiments. At the bottom of tube 103 a reducer 109 reduces the diameter, and a flow control device 110 has an adjustable opening to vary the flow of material and water out of tube 103.

It is important that spiral track 107 fit well between central pipe 106 and tube 103. If there is a poor fit water and perhaps material mix may leak around the track where it contacts tube 103 and central pipe 106. The track may in one implementation be made in a straight form from heat formable plastic material, and then formed into final position with aid of special fixtures. In another embodiment the track may be made by 3D printing.

FIG. 2B is an enlarged view of the upper end of central pipe 106 with cap 108, showing holes and indicating water flow. Chute 104 is not shown in this view. Cap 108 in assembly is joined to central pipe by adhesive in this example. Holes 113 in cap 108 enable water flow from central pipe 106 to enter the region between the outside of central pipe 106 and the inside wall of tube 103. A spiral track 107 is implemented in the region between the outside of central pipe 106 and the inside wall of tube 103, such that dry material added into chute 104 will be washed down the spiral track by the water from cap 108. The nature of the spiral track is seen in both FIG. 2A and FIG. 2B, but only the back half of the track is seen, as the figures are in cross section.

Referring back to FIG. 2A the spiral track is seen down the height of the apparatus between the central pipe and the inside of the outer tube. Additional holes 114 through central pipe 106 are strategically placed down the height of central pipe 106 to wash lighter materials to the outside of the spiral track as material is processed.

FIG. 2C is an enlarged portion of the cross section of FIG. 2A showing a specific portion of the apparatus in section, with magnetically permeable plates 115 engaged in grooves in an outside surface of tube 103. Each plate 115 is, in this example, is an iron plate one sixteenth inch thick, one quarter inch wide and one inch long. Grooves of these dimensions are machined in the outer wall of tube 103 to mount the plates or attach with adhesive. Each groove with a plate installed has a bottom edge even with a top instance of the spiral track and extends upward. The spiral period of the track is 2.5 inches as shown in FIG. 2C, so the plate at each position covers one inch of the 2.5 inch dimension between instances of the track. In this implementation magnetically permeable plates are placed in grooves around tube 103 at ninety-degree intervals. In other embodiments the plates and grooves may assume different shapes and dimensions.

FIG. 2D is a further enlarged portion of a part of FIG. 2C, showing just one instance of passage of the spiral track and one groove with a magnetically permeable plate 115 in place. In this example a permanent magnet 116 has been placed on the magnetically permeable plate, creating a magnet assembly 105 comprising the magnetically permeable plate 115 and the permanent magnet 116. The magnetically permeable plate 115 with the magnet added has an effect of extending and shaping the magnetic field produced, which is indicated by dotted lines 117. The field to the outside of tube 103 is not shown, and the extended field is not shown either. The concentrated field particularly in the volume inside of tube 103 at the inner wall where the wall meets the track 107 is of the most interest.

FIG. 2E illustrates a result of processing material mixture in the apparatus. Referring back to FIG. 2A, water is caused to flow into inner pipe 106 through inlet tube assembly 102, and flow upward under pressure in central pipe 106. Water jets outwardly through holes 114 in the wall of central pipe 106 just above instances of the spiral track between central pipe 106 and outer tube 103. At the top of central pipe 106 water flows out of cap 108 through holes 113 and flows down the spiral track. Material mix that may comprise magnetite sand and other particles is placed into the system through chute 104, and the water flow down the spiral track entrains the material and carries the material down the track. Typically, heavier material, like for example gold, will tend toward the inside, toward the centerline, and lighter material will tend to the outside. Further, the water jets from holes 114 help to urge material to the outside.

As entrained mixture passes down around track 107 and encounters magnetic fields presented by magnetic assemblies 105 magnetite material is trapped in the magnetic fields as represented by particles 118 in FIG. 2E. Entrained material flows down the full height of the apparatus through a plurality of magnetic fields and exits along with the water flow at the bottom of tube 103 where it passes through reducer 109 and flow controller 110.

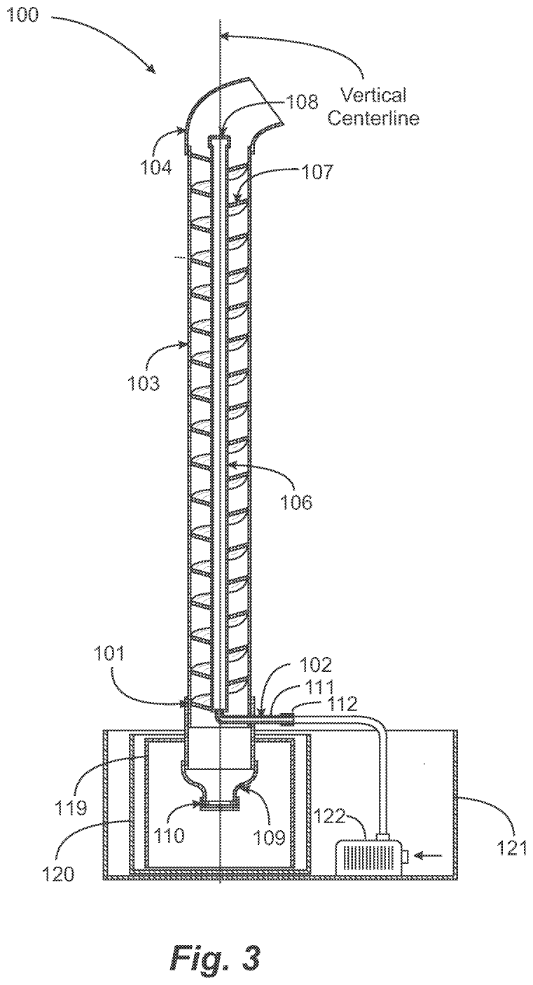

As described above, plastic bucket 119 is open at the bottom end. In practice apparatus 100 including bucket 119 may be placed in a larger upright bucket 120 as illustrated in FIG. 3 and both may be placed in a tub 121 filled with water (magnets are not shown in FIG. 3 but may be assumed to be present). In this configuration a pump 122 may provide water from the tub to inlet assembly 102, up through the apparatus and down along the spiral track to upright bucket 120. Processed material with magnetite removed is captured in upright bucket 120 and water overflows the top of bucket 120 into tub 121, so water is recirculated in the system and processed material is captured. The captured, processed material may be removed by shutting off the pump, lifting bucket 120 from tub 121 along with apparatus 100, then lifting apparatus 100 from bucket 120. A new, empty bucket 120 may be placed in tub 121 and apparatus 100 replaced in the new empty bucket to remove the magnetite material entrained in the magnetic fields in apparatus 100.

To remove the entrained magnetite material, it is necessary to remove the magnets that provide the magnetic fields, collapsing the magnetic fields. In one implementation as depicted in FIGS. 2D and 2E magnetically permeable plates 115 are positioned in grooves in the outer wall of tube 103 at strategic places. These plates my be fixed in the grooves by adhesive or held in some other way. The plates are magnetically permeable but are not magnetized, so they do not by themselves provide strong magnetic fields into the apparatus. The magnetic fields are provided by permanent magnets 116 placed on the plates, and the plates help shape the fields. In one embodiment the permanent magnet is a commercially available permanent magnet know is Neodymium N52. At the point of needing to remove the magnetite material from the apparatus after a processing cycle the user may manually remove the permanent magnets from the plates. A plier or other tool may be used, as the attraction to the plates is quite strong. Once the permanent magnets are removed from the plates, with the apparatus in place in upright bucket 120, the user may restart the pump and flush the captured magnetite into upright bucket 120.

After flushing the captured magnetite material into upright bucket 120 the user may turn off the pump, lift the apparatus, replace the upright bucket, replace the apparatus in the upright bucket. Replace the permanent magnets onto the magnetically permeable strips and start a new cycle.

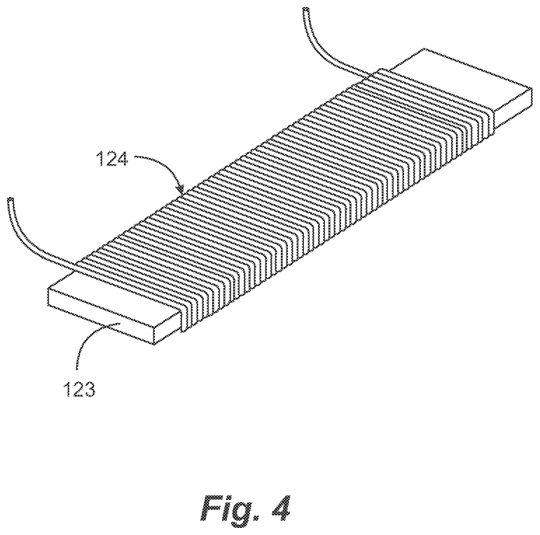

In an alternative embodiment the magnet assemblies might be electromagnets rather than being powered by permanent magnets. FIG. 4 is a perspective view of a magnetically permeable strip 123 similar to strip 115 and about the same size. Strip 123 is tightly wrapped with electrically conducting wire 124. The wire size and number of wraps are representative and not quantitative. A direct current passed through the wire will provide an electromagnet with a N and S pole very much like the permanent magnet assembly described above. The wire size and turns as well as current may be altered to provide needed field strength.

The processed material with magnetite removed may now be passed through one or another of gravity separation devices to recover, for example, gold from the mixture. All separation devices, such as clutriators, slaking tables, jigs, spiral cones, Gold Cubes, even the Gokd Pan function more efficiently when the magnetite sand in removed.

An apparatus according to the invention may be provided with electromagnets permanently or semi-permanently installed at the points described above for separation of Magnetite material from sample material washed down the spiral track. DC current is preferred. The magnets will be wired in parallel from a voltage source, and a switch may be provided to turn the magnets on and off.

It will be apparent to the skilled artisan that the embodiments described are entirely exemplary, and that there are other ways that different elements of the apparatus and steps in processes may be provided within the scope of the invention. For example, the apparatus is scalable, and may be provided in a variety of sizes. The period of the spiral track may be different in different embodiments. In fact there may be two spiral tracks intertwined with each other within the outer pipe. The elements for collecting products of processing may be provided in different ways as well.

There are a variety of ways that the magnet assemblies may be implemented, and a variety of ways that they may be applied to the apparatus and removed at need. In one implementation magnet assemblies may be attached to a removable column or carriage that has the magnets permanently attached to it. The assembly releases at the top, hinged at the bottom so the apparatus opens like a clam shell. Once the assembly is opened, the magnetic field is diminished and the magnetic sand is released. The assembly is then closed and ready to be reused.

The processed material with magnetite removed may now be passed through one or another of gravity separation devices to recover, for example, gold from the mixture. All separation devices, such as elutriators, slaking tables, jigs, spiral cones, Gold Cubes, even the Gold Pan function more efficiently when the magnetite sand is removed.

Magnets may be fixed to fabric tape which may be wrapped around the outside of tube 103 in a spiral matching the spiral period of the spiral track of the apparatus, in a manner that the magnet assemblies are placed as shown in the figures. Alternatively, magnet assemblies may be attached to a thin plastic strips that may be joined to tube 103 as vertical strips of magnets. In this implementation there may be as many as four vertical strips. The plastic strips may be attached to tube 103 in different ways, such as by velcro, or by elastic loops around tube 103.

1. A separation apparatus, comprising:
a vertically-oriented first tube having an inside diameter and a height;
a second tube having an outside diameter substantially smaller than the inside diameter of the first tube and substantially the height of the first tube, the second tube concentric with the first tube, the tubes having a common center-line;
a spiral track implemented between the inside diameter of the first tube and the outside diameter of the second tube, the spiral track descending along substantially the height of the first and second tubes; and
a plurality of magnet assemblies, individual ones of the magnet assemblies positioned on an outside wall of the first tube, providing magnetic fields through the outside wall of the first tube into regions where the spiral track meets the inside diameter of the first tube;
wherein a material mixture comprising magnetic particles is introduced at an upper end of the apparatus, entrained in a flow of water down the spiral track, and some of the magnetic particles are separated from the material mixture and retained in the magnetic field of individual ones of the magnet assemblies.

2. The separation apparatus of claim 1 further comprising a container having an open top into which the apparatus empties such that processed material with magnetic particles removed is collected.

3. The separation apparatus of claim 1 wherein the magnetic particles constitute magnetite sand.

4. The separation apparatus of claim 1 wherein water is fed to the second tube at a lowermost point, travels up the second tube, exits at a top of the second tube, flows onto the spiral track between the tubes, and material mixture is added to the water flow in the spiral track.

5. The separation apparatus of claim 1 wherein the magnet assemblies are positioned on the outside wall of the first tube in regular increments following down the spiral track.

6. The separation apparatus of claim 1 wherein the magnet assemblies each comprise a permanent magnet.

7. The separation apparatus of claim 6 wherein the permanent magnets are Neodymium N52 magnets.

8. The separation apparatus of claim 1 wherein the magnet assemblies each comprise a permanent magnet joined to a magnetically permeable strip, the strip shaping the magnetic field.

9. The separation apparatus of claim 1 wherein the first tube has a reducer fitting at a lower end of the first tube, further comprising a manually-adjustable flow controller coupled to the reducer fitting, enabling control of volume flow of entrained material and water down the spiral track.

10. The separation apparatus of claim 1 further comprising horizontally directed holes through a wall of the second tube at specific points along the spiral track and a cap with holes at the top of the second tube, such that water under pressure provided to the first tube at the lowermost end is directed outward over the spiral track at the specific points, and urges material to the outside of the spiral track.

11. A method for separating magnetic particles from a material mixture, comprising:
implementing a spiral track between first and a second concentric tubes;
positioning magnet assemblies at specific points on the outside of the first tube along the spiral track, proving magnetic fields through the first tube;
introducing a material mixture containing the magnetic particles onto the spiral track;
flowing water onto the spiral track entraining the material mixture; and
capturing magnetic particles in the magnetic fields.

12. The method of claim 11 further comprising collecting processed material mixture at the lower end of the spiral track in a container having an open top.

13. The method of claim 11 comprising introducing a material mixture comprising magnetite sand.

14. The method of claim 11 comprising feeding water to the second tube at a lowermost point, urging the water up the second tube, flowing the water out at the top of the second tube, flowing the water onto the spiral track between the tubes, and adding material mixture to the water flow in the spiral track.

15. The method of claim 11 comprising positioning the magnet assemblies on the outside wall of the first tube in regular increments following down the spiral track.

16. The method of claim 11 comprising providing a permanent magnet with each magnet assembly.

17. The method of claim 16 comprising providing a Neodymium N52 magnet to each magnet assembly.

18. The method of claim 11 comprising joining a permanent magnet to a magnetically permeable strip for each magnet assembly.

19. The method of claim 11 wherein the first tube has a reducer fitting at a lower end of the first tube, further comprising a manually-adjustable flow controller coupled to the reducer fitting, enabling control of volume flow of entrained material and water down the spiral track.

20. The method of claim 11 further comprising placing horizontally directed holes through a wall of the second tube at specific points along the spiral track and closing the top of the second tube with a cap having holes, such that water under pressure provided to the first tube at the lowermost end is directed outward over the spiral track at the specific points, and urges material to the outside of the spiral track.
